(19) United States
(12) Patent Application Publication
(10) Pub. No.: US 2004/0268086 A1
(43) Pub. Date: Dec. 30, 2004

(54) Operating external application through image forming apparatus

(76) Inventors: Yoh Masuyama, Kanagawa (JP); Junji Ukegawa, Kanagawa (JP); Takashi Soyama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/801,006

(22) Filed: Mar. 16, 2004

(30) Foreign Application Priority Data
Mar. 17, 2003 (JP) 2003-072626
Feb. 27, 2004 (JP) 2004-054323

(51) Int. Cl. G06F 9/44

(52) U.S. Cl. 712/1

(57) ABSTRACT

An image forming apparatus, in which software is used for forming an image, includes a display unit, a display information controlling unit configured to control information displayed on the display unit, an interface unit configured to provide a physical connection with an external apparatus on which an application is implemented, a control unit configured to control the interface unit and provide a logical connection with the external apparatus, and a relay unit configured to relay between the application and the software, the relaying unit notifying the display information controlling unit of a display that is to be presented on the display unit to indicate ongoing preparation of the application until the application becomes operational when the control unit provides the logical connection with the external apparatus.

### BACKGROUND OF THE INVENTION

1. Field of the Invention

The present invention generally relates to an image forming apparatus, and particularly relates to an image forming apparatus which allows an application of an external apparatus to be operated through the image forming apparatus.

2. Description of the Related Art

In recent years, an image forming apparatus that combines a plurality of machine-specific functions such as those of a facsimile machine, a printer, a copier, a scanner, etc., in one device has become widely popular. This image forming apparatus is provided with a display unit, a print unit, an imaging unit, etc., in one device, and is also provided with four applications corresponding to a facsimile machine, a printer, a copier, and a scanner, respectively. Switching of the applications provides for the image forming apparatus to perform any desired functions of a printer, a copier, a facsimile machine, and a scanner.

The image forming apparatus as described above is sometimes provided with an interface such as a PCI or a USB for connecting with an external apparatus on which an application is implemented. Attaching an external apparatus to this interface makes it possible to enhance or expand the function of the image forming apparatus.

It requires a lengthy time for such external apparatus to prepare to operate with the image forming apparatus. When a user wishes to use the external apparatus during such a time period, the user cannot decide whether the external apparatus is not operating because preparation is being made or because the external apparatus is not properly connected.

Further, the image forming apparatus is provided with a relay application used for conducting communication with an external apparatus. The relay application is laid out in memory in the same manner as other routine applications. When an external apparatus is not connected, the relay application ends up wasting a memory space.

Accordingly, there is a need for an image forming apparatus and a method of operating an external application that allow a user to check a connection with an external apparatus, and also allow the efficient use of memory.

### SUMMARY OF THE INVENTION

It is a general object of the present invention to provide an image forming apparatus and a method of operating an external application that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an image forming apparatus and a method of operating an external application particularly pointed out in the specification in such full, clear, concise, and exact terms as to enable a person having ordinary skill in the art to practice the invention.

To achieve these and other advantages in accordance with the purpose of the invention, an image forming apparatus, in which software is used for forming an image, includes display unit, a display information controlling unit configured to control information displayed on the display unit, an interface unit configured to provide a physical connection with an external apparatus on which an application is implemented, a control unit configured to control the interface unit and provide a logical connection with the external apparatus, and a relay unit configured to relay between the application and the software, the relaying unit notifying the display information controlling unit of a display that is to be presented on the display unit to indicate ongoing preparation of the application until the application becomes operational when the control unit provides the logical connection with the external apparatus.

According to another aspect of the invention, the display information controlling unit makes the display unit present the display in response to an attempt by a user to use the application.

According to another aspect of the invention, the control unit notifies the relay unit that no communication is possible, in response to a physical or logical disconnection occurring with respect to the external apparatus.

According to another aspect of the invention, the image forming apparatus further includes a starting unit configured to start the relay unit.

According to another aspect of the invention, the starting unit starts the relay unit after the external apparatus is physically connected.

According to another aspect of the invention, the starting unit utilizes the control unit to check whether the external apparatus is physically connected.

According to another aspect of the invention, the image forming apparatus further includes a registering unit configured to register the application, such registration making the application operable through the image forming apparatus.

According to another aspect of the invention, the registering unit unregisters the application in response to a request from the relay unit.

According to another aspect of the invention, the relay unit requests the registering unit to unregister the application, such request being made in response to a notice from the control unit indicating that no communication is possible.

According to another aspect of the invention, when the registering unit unregisters the application, the display information controlling unit switches the information displayed on the display unit to other information if the information displayed on the display unit is associated with the application.

According to another aspect of the invention, the other information is associated with the software.

According to another aspect of the invention, the registering unit is configured to register the application again if the external apparatus is reconnected after the application is unregistered.

According to another aspect of the invention, the image forming apparatus further includes a program unregistering unit which unregisters the relay unit by releasing a memory area in which a program of the relay unit is laid out.

According to another aspect of the invention, the relay unit, responding to a notice from the control unit indicating that no communication is possible, notifies the starting unit that the application is unregistered, and requests the program unregistering unit to unregister the application.

According to another aspect of the invention, the relay unit is restarted by the starting unit if the external apparatus is connected after the relay unit is unregistered.

According to another aspect of the invention, the relay unit, responding to a notice from the control unit indicating that no communication is possible during execution of the application, notifies the display information controlling unit of a display that is to be presented on the display unit to indicate error occurrence.

According to another aspect of the invention, the image forming apparatus further includes an email sending unit, wherein the relay unit, responding to a notice from the control unit indicating that no communication is possible during execution of the application, instructs the email sending unit to send email indicative of error occurrence to a predetermined mail address.

According to another aspect of the invention, a method of allowing an external application to be operated through an image forming apparatus having a display unit, the external application being implemented in an external apparatus connectable to the image forming apparatus, includes the steps of connecting the external apparatus to the image forming apparatus, preparing a display that indicates ongoing preparation until the application becomes operational, and presenting the display on the display unit until the application becomes operational in response to an attempt by a user to use the application.

In the invention described above, an image forming apparatus and a method of operating an external application allow a user to check a connection with the external apparatus, and provides for efficient use of memory to be made.

Other objects and further features of the present invention will be apparent from the following detailed description when read in conjunction with the accompanying drawings.

### BRIEF DESCRIPTION OF THE DRAWINGS

FIG. 1 is a block diagram showing an embodiment of a multifunction peripheral according to the invention;

FIG. 2 is a block diagram showing a hardware construction of an embodiment of the multifunction peripheral;

FIG. 3 is a block diagram showing a connection between an external-application relaying module and an external application;

FIG. 4 is a sequence chart showing a start-up procedure for the external application by which the external application registers its ID so as to allow a user to use the external application on the multifunction peripheral;

FIG. 5 is an illustrative drawing showing a display indicative of ongoing preparation;

FIG. 6 is a diagram showing a structure of data for notifying of the starting up of the external application;

FIG. 7 is a sequence diagram showing a procedure for canceling registration;

FIG. 8 is a sequence chart showing a procedure that is performed when physical disconnection occurs such as when the external application is disconnected from the multifunction peripheral;

FIG. 9 is a sequence chart showing a procedure that is performed at the time of disconnection; and

FIG. 10 is a sequence chart showing another procedure that is performed at the time of disconnection.

### DESCRIPTION OF THE PREFERRED EMBODIMENTS

In the following, embodiments of the present invention will be described with reference to the accompanying drawings.

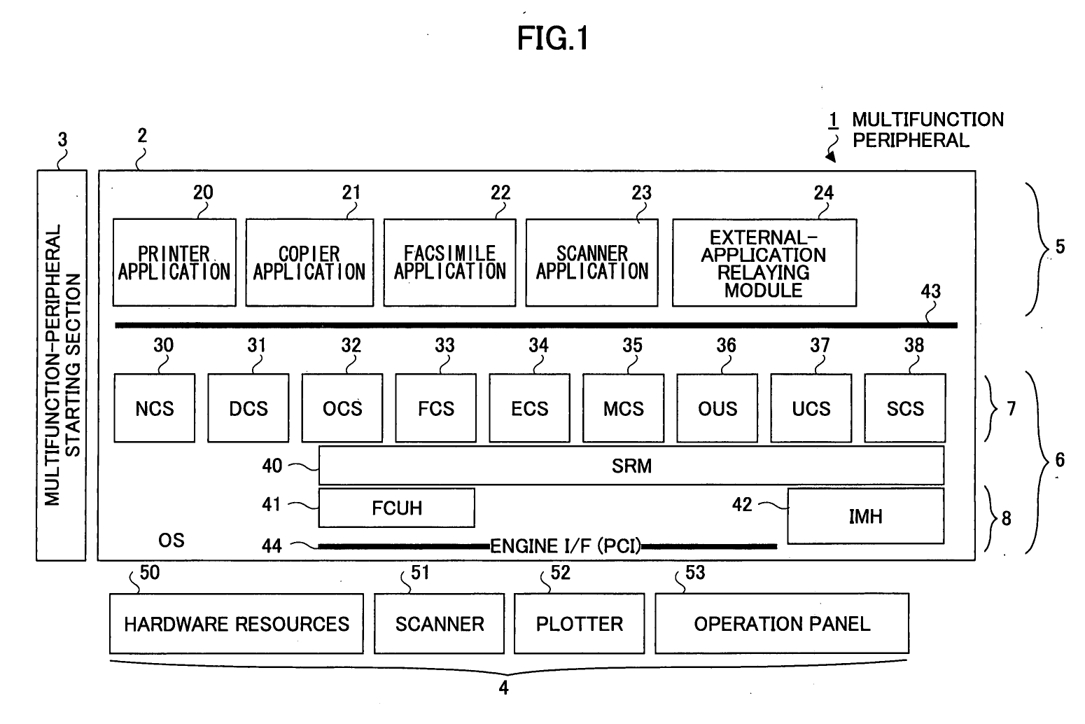

FIG. 1 is a block diagram showing an embodiment of a multifunction peripheral 1 according to the invention. The multifunction peripheral 1 includes a program set 2, a multifunction-peripheral starting section 3, and hardware resources 4.

The multifunction-peripheral starting section 3, which may also be referred to as a starting unit, operates upon the power-on of the multifunction peripheral 1 first, and starts an application layer 5 and a controller 6. For example, the multifunction-peripheral starting section 3 reads programs for the application layer 5 and the controller 6 from a hard disk drive (HDD) or the like, and transfers these programs to respective memory areas for execution. The hardware resources 4 include a scanner 51, a plotter 52, an operation panel 53, and hardware resources 50, which may include a facsimile and the like.

The program set 2 includes the application layer 5 and the controller 6, which are executed on an operating system (hereinafter referred to as an OS) such as UNIX (registered trademark). The application layer 5 includes programs for user-service-specific processes relating to image formation such as a printer, a copier, a facsimile, a scanner, etc.

The application layer 5 includes a printer application 20 used for a printer, a copier application 21 used for a copier, a facsimile application 22 used for a facsimile, a scanner application 23 used for a scanner, and an external-application relaying module 24 serving as a relaying unit for relaying between the multifunction peripheral and an external apparatus connected to the multifunction peripheral.

The controller 6 includes a control service layer 7 which interprets a processing request from the application layer 5 to generate a request for acquiring the hardware resources 4, a system resource manager (SRM) 40 which manages one or more hardware resources 4 to arbitrate acquisition requests from the control service layer 7, and a handler layer 8 which manages the hardware resources 4 in response to the acquisition request from the SRM 40.

The control service layer 7 is configured to include one or more service modules such as a network control service (NCS) 30, a delivery control service (DCS) 31, an operation panel control service (OCS) 32, a fax control service (FCS) 33, an engine control service (ECS) 34, a memory control service (MCS) 35, an on-demand update service (OUS) 36, a user information control service (UCS) 37, and a system control service (SCS) 38.

The controller 6 is configured to include API 43 through a preset function, which makes it possible to receive a processing request from the application layer 5. The OS executes processes in parallel with respect to the software of the application layer 5 and the software of the controller 6.

The process of the NCS 30 provides services which are used by applications that need network I/O. This process serves as an intermediary to distribute data to each application as the data is received through respective protocols from networks and to transmit data to the networks as the data is received from each application.

For example, the NCS 30 controls data communication with network apparatus connected through the networks by HTTP (HyperText Transfer Protocol) by use of the httpd (HyperText Transfer Protocol Daemon).

The process of the DCS 31 controls distribution of accumulated documents and the like. The process of the OCS 32 controls an operation unit, which is used as an interface for communication between a service maintenance person or a user and a control unit. The process of the FCS 33 provides API for performing fax transmission and reception through the PSTN or ISDN network for the application layer 5, the registration/referencing of various fax data stored in backup memory, fax scanning, received fax printing, etc.

The process of the ECS 34 controls engine units such as the scanner 51, the plotter 52, and the hardware resources 50. The process of the MCS 35 performs memory control such as the acquisition and release of memory and the use of HDD, etc. The OUS 36 downloads a program in response to a notice from the network, and lays out the program in memory. The process of the UCS 37 manages user information.

The process of the SCS 38 attends to application management, operation-panel control, system screen display, LED display, hardware resource management, interruption application control, etc. The SCS 38 may serve as a display information controlling unit, a registering unit, a program unregistering unit, and an email transmitting unit.

The process of the SRM 40 together with the SCS 38 attend to system control and the management of the hardware resources 4. For example, the process of the SRM 40 arbitrates in response to acquisition requests from the higher-order layers that are in need of using the hardware resources 4 such as the scanner 51 and the plotter 52, thereby performing execution control.

Specifically, the process of the SRM 40 checks whether the hardware resources 4 requested for acquisition are available. If they are available, the process of the SRM 40 notifies the higher-order layer that the hardware resources 4 requested for acquisition are available. Moreover, the process of the SRM 40 attends to scheduling for use of the hardware resources 4 in response to the acquisition requests from the higher-order layers, and carries out what is requested, i.e., paper feeding and imaging by the printer engine, memory allocation, file generation, etc.

Moreover, the handler layer 8 includes a fax control unit handler (FCUH) 41 that controls and manages a fax control unit (FCU), which will be described later. The handler layer 8 further includes an image memory handler (IMH) 42, which manages the allocation of memory areas to processes and to manage the memory areas assigned to the processes. The SRM 40 and the FCUH 41 issue a processing request to the hardware resources 4 by use of an engine I/F 44, which enables transmission of the processing request to the hardware resources 4 by use of a predefined function.

In this manner, the multifunction peripheral 1 uses the controller 6 to achieve central processing of various processes required by each application. In the following, the hardware construction of the multifunction peripheral 1 will be described.

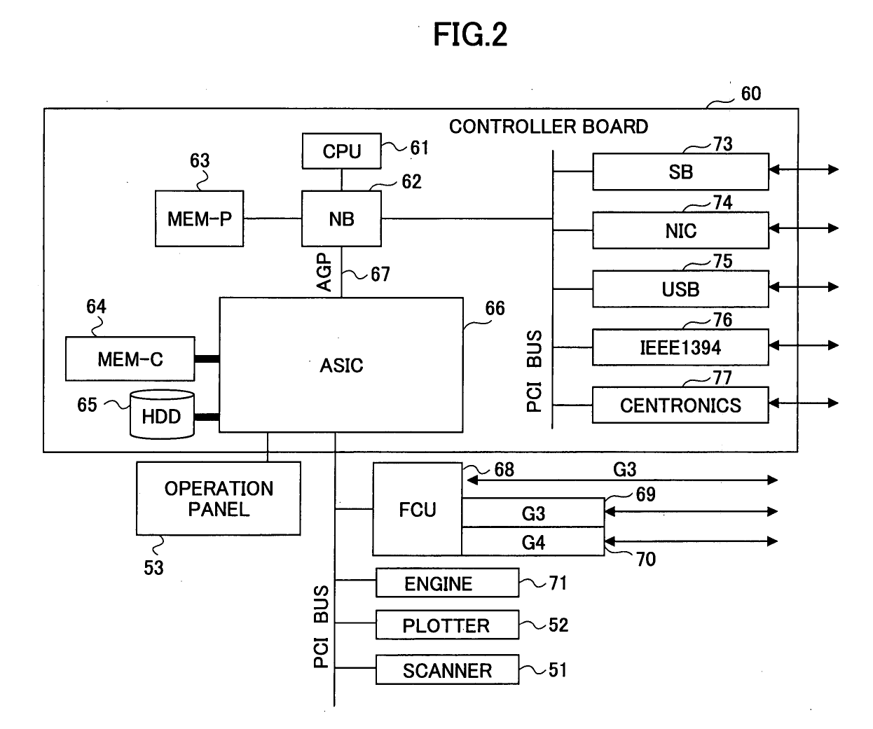

FIG. 2 is a block diagram showing a hardware construction of an embodiment of the multifunction peripheral 1. The multifunction peripheral 1 includes a controller board 60, an operation panel 53, a FCU 68, an engine 71, the scanner 51, and the plotter 52 serving as a printing unit. The FCU 68 includes a G3-standard complying unit 69 and a G4-standard complying unit 70.

The controller board 60 includes a CPU 61, an ASIC 66, an HDD 65, a system memory (MEM-P) 63, a local memory (MEM-C) 64, a north bridge (NB) 62, a south bridge (SB) 73, a NIC 74 (Network Interface Card), a USB device 75, an IEEE1394 device 76, and a Centronics device 77.

The operation panel 53 is connected to the ASIC 66 of the controller board 60. The SB 73, the NIC 74, the USB device 75, the IEEE1394 device 76, and the Centronics device 77 are all connected to the NB 62 through the PCI bus.

The FCU 68, the engine 71, the scanner 51, and the plotter 52 are connected to the ASIC 66 of the controller board 60 through the PCI bus.

In addition, the controller board 60 has the local memory 64 and the HDD 65 connected to the ASIC 66, and the CPU 61 and the ASIC 66 are connected through the NB 62 of a CPU chip set. Connecting the CPU 61 and the ASIC 66 together through the NB 62 in this manner makes it possible to cope with such a situation as the interface of the CPU 61 is not released to the public.

The ASIC 66 and the NB 62 are connected not through the PCI bus but through AGP (accelerated graphics port) 67. In this manner, the ASIC 66 and the NB 62 are connected through the AGP 67 instead of the low-speed PCI bus, thereby avoiding a drop of performance when controlling the execution of one or more processes which form the application layer 5 and the controller 6 of FIG. 1.

The CPU 61 is responsible for overall control of the multifunction peripheral 1. The CPU 61 starts and executes the NCS 30, the DCS 31, the OCS 32, the FCS 33, the ECS 34, the MCS 35, the OUS 36, the UCS 37, the SCS 38, the SRM 40, the FCUH 41, and the IMH 42 as processes on the OS, and also starts and executes the printer application 20, the copy application 21, the fax application 22, the scanner application 23, and the external-application relaying module 24, which make up the application layer 5.

The NB 62 is a bridge for connecting the CPU 61, the system memory 63, the SB 73, and the ASIC 66. The system memory 63 is used as a picture-rendering memory and the like of the multifunction peripheral 1. The SB 73 is a bridge for connecting the NB 62, the PCI bus, and peripheral devices. The local memory 64 is used as a copy-purpose image buffer and also as a code buffer.

The ASIC 66 is an image-processing-purpose IC that includes hardware elements for image processing. The HDD 65 is a storage for storing images, document data, programs, font data, forms, etc. The operation panel 53 serving as an operating unit and a display unit is operated by a user to receive input data from the user, and provides display presentation to the user.

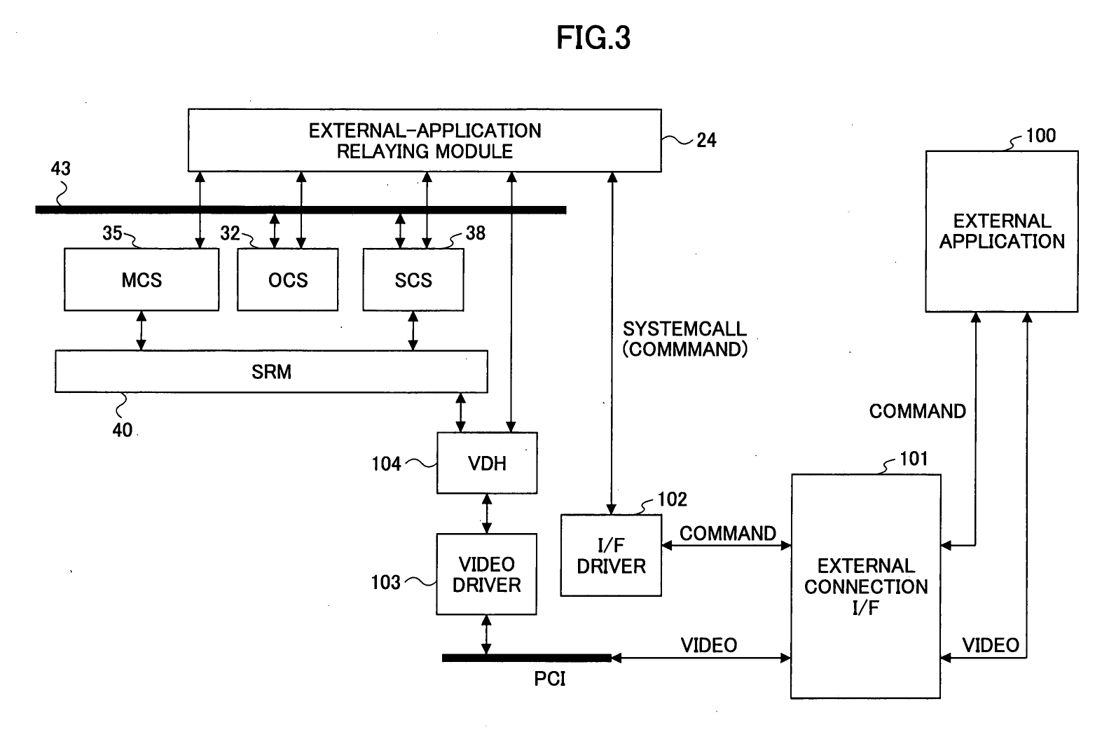

In the following, a description will be given of the external-application relaying module 24 and an external application of external apparatus. FIG. 3 is a block diagram showing a connection between the external-application relaying module 24 and an external application 100. In FIG. 3, the same elements as those of FIG. 1 are referred to by the same numerals, and a description thereof will be omitted. The external application 100 is software implemented on an external apparatus. In the following description, however, the term “external application 100” may sometimes be used to refer to the external apparatus itself.

FIG. 3 shows the external-application relaying module 24, the API 24, the MCS 35, the OCS 32, the SCS 38, the SRM 40, a VDH (video driver handler) 104, a video driver 103, an I/F driver 102, an external connection I/F 101, and the external application 100. The I/F driver 102 serves as a control unit.

The external-application relaying module 24 is provided for the purpose of making the external application 100 operate as if it was an application of the multifunction peripheral 1. Making the external application 100 operate as an application of the multifunction peripheral 1 makes it possible to effectively utilize the programs of the multifunction peripheral 1 of FIG. 1.

In this embodiment, the external application 100 serves as a printer application, and exchanges commands and video data with the multifunction peripheral 1. The external application 100 may alternatively be another application.

The external connection I/F 101 serving as an interface unit is a physical interface to which the external application 100 is connected. The I/F driver 102 is software used by the external-application relaying module 24 for driving the external connection I/F 101 for exchange of commands with the external application 100.

The video driver 103 is used when exchanging video data through the external connection I/F 101. The VDH 104 is a handler for the video driver 103, and is used by the external-application relaying module 24 and the SRM 40.

With this provision, the external-application relaying module 24 exchanges commands and video data with the external application 100, thereby making the external application 100 operate as if it was an application of the multifunction peripheral 1.

Accordingly, the external application 100 registers its own ID in the SCS 38 upon power-on, like other applications of the multifunction peripheral 1. With this registration, the external application 100 can operate meaningfully, e.g., by allowing a user to use the external application 100.

In the following, a description will be given of a procedure by which an application on the multifunction peripheral 1 becomes usable by a user.

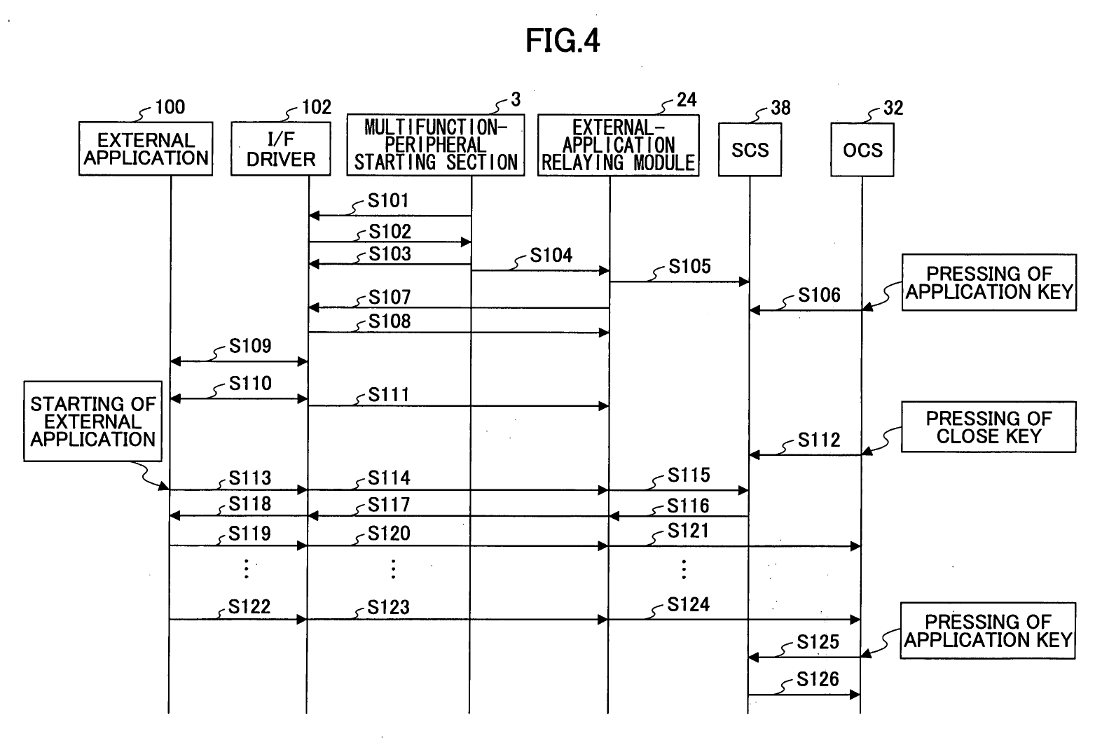

FIG. 4 is a sequence chart showing a start-up procedure for the external application 100 by which the external application 100 registers its ID in the SCS 38 so as to allow a user to use the external application 100 on the multifunction peripheral 1.

At step S101, the multifunction-peripheral starting section 3 executes a system call for letting the I/F driver 102 open a port for the purpose of checking whether the external application 100 is physically connected. At step S102, it is ascertained that physical connection is present if the opening of the port succeeds. At step S103, the port that was opened is closed. At step S104, the multifunction-peripheral starting section 3 starts the external-application relaying module 24.

At step S105, the external-application relaying module 24 sends an application pre-registration preparation notice to the SCS 38 to indicate that the external application 100 is physically connected but preparation is underway for making the external application 100 usable. This notice is provided for the purpose of letting the SCS 38 know a display indicative of the ongoing preparation of the external application 100, which will be displayed when a user attempts to use the external application 100. Having received this pre-registration preparation notice, the SCS 38 can display a sign indicative of the ongoing preparation of the external application 100 on the operation panel 53.

Presentation of such display is made in response to a notice sent from the OCS 23 at step S106 that indicates the pressing of an application key, which is pressed when the user wishes to use the external application 100. FIG. 5 is an illustrative drawing showing the display indicative of ongoing preparation. In FIG. 5, a message 110 showing “Please wait. Preparation is underway.”, and a close key 111 are provided. The message 110 informs the user that the external application 100 is being prepared. The close key 111 is used to close the display shown in FIG. 5. As the close key 111 is pressed, a notice indicative of the pressing of the close key 111 is sent from the OCS 32 to the SCS 38, as shown at step S112.

If the external application 100 is not connected, an alarm sound may be made in response to the pressing of an application key by the user. A message indicative of no connection may be displayed at the position where the message 110 is shown in FIG. 5.

In this manner, the user will know whether the external apparatus is not usable because of an ongoing start-up procedure or is not usable because of no connection.

With reference to FIG. 4 again, at step S107, the external-application relaying module 24 executes a system call to let the I/F driver 102 open a port. At step S108, the opening of the port succeeds.

At step S109 after the successful opening of the port, connection signals are exchanged between the I/F driver 102 and the external application 100. At step S110, exchanges are made according to a start-up protocol.

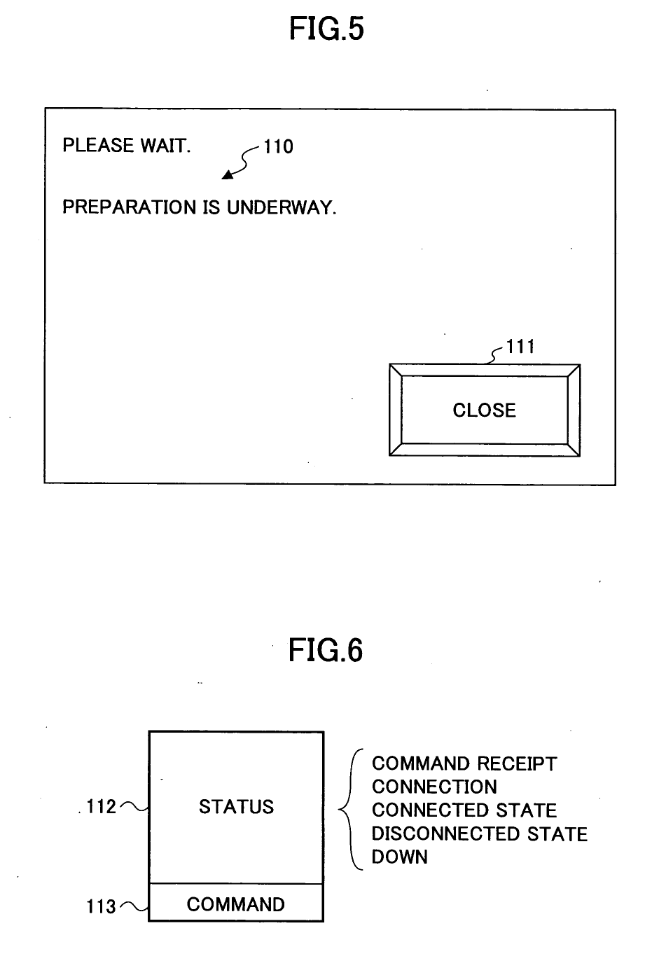

The step S109 and the step S110 logically connect the external application 100 with the multifunction peripheral 1, thereby providing an environment where communication is properly made. At step S111, the I/F driver 102 notifies the external-application relaying module 24 that the external application 100 is started. FIG. 6 is a diagram showing a structure of data for notifying of the starting up of the external application 100. This data structure includes status data 112 and command data 113.

The status data 112 indicates the status of the external application 100, and also indicates that the contents of the command data 113 are commands. The status data 112 includes “Command Receipt”, “Connection”, “Connected State”, “Disconnected State”, and “Down”. “Command Receipt” indicates that commands from the external application 100 are stored in the command data 113. “Connection” indicates that communication with the external application 100 has become possible. “Connected State” indicates a state in which connection with the external application 100 is maintained. “Disconnected State” indicates a state in which connection with the external application is severed. “Down” indicates that the external application 100 is down. Here, “Disconnected State” and “Down” are notices indicating that no communication is possible.

With the data structure described above, the I/F driver 102 and the external-application relaying module 24 communicate with each other.

At step S111, specifically, the data having “Connection” in the status data 112 is sent to the external-application relaying module 24, so that the external-application relaying module 24 learns that communication is now possible with the external application 100.

After the external application 100 is started, the external application 100 attends to application registration at step S113. This application registration registers the ID of the external application 100 in the SCS 38 so as to make the external application 100 operable through the multifunction peripheral 1. This is a procedure performed not only by the external application 100 but also by the printer application 20, the copy application 21, etc.

The I/F driver 102 receives a request for application registration from the external application 100 at step S113, and sends the request to the external-application relaying module 24. At step S115, the external-application relaying module 24 notifies the SCS 38 of the application registration requested by the external application 100.

Having been notified, the SCS 38 registers the ID of the external application 100, and sends to the external-application relaying module 24 an OCS ready at step S116 to indicate that the external application 100 is allowed to draw on the display of the operation panel 53. At step S117, the external-application relaying module 24 sends the OCS ready to the I/F driver 102. At step S118, the I/F driver 102 notifies the external application 100 of the OCS ready.

Having received the OCS ready, the external application 100 uses the OCS 32 to draw a display that is to be displayed when the user uses the external application 100. Such drawing is done at steps S119, S120, and S121 through the I/F driver 102 and the external-application relaying module 24.

After finishing drawing on the display, the external application 100 notifies the OCS 32 of the completion of drawing. Such notification is made at steps S122, S123, and S124 through the I/F driver 102 and the external-application relaying module 24.

With this, the user can now use the external application 100. When the user presses an application key, the OCS 32 notifies the SCS 38 of the pressing of the application key at step S125. At step S126, the SCS 38 instructs the OCS 32 to present the prepared display of the external application 100, thereby having the display of the external application 100 presented.

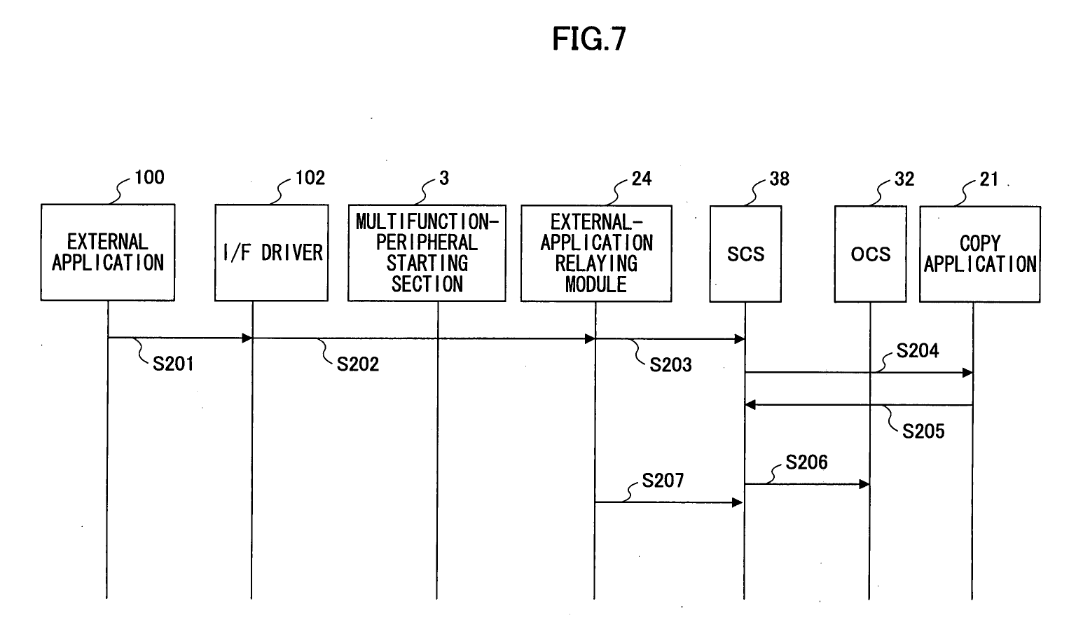

In the procedure described above, the external application 100 registers in the SCS 38. FIG. 7 is a sequence diagram showing a procedure for canceling the registration.

At step S201, the external application 100 sends a command for application unregistration to the I/F driver 102. At step S202, the I/F driver 102 notifies the external-application relaying module 24 of application unregistration. At step S203, the external-application relaying module 24 notifies the SCS 38 of application unregistration of the external application 100.

If the display of the external application 100 is presented on the operation panel 53 at the time of unregistration, such presentation is brought to an end, followed by presenting another application display. For example, the copy application 21 may present its display. At step S204, the SCS 38 inquires the copy application 21 whether its display can be presented. At step S205, the copy application 21 notifies the SCS 38 that the display can be presented. At step S206, the OCS 32 is instructed to present the display of the copy application 21.

Further, the external-application relaying module 24 sends an application pre-registration preparation notice to the SCS 38 at step S207.

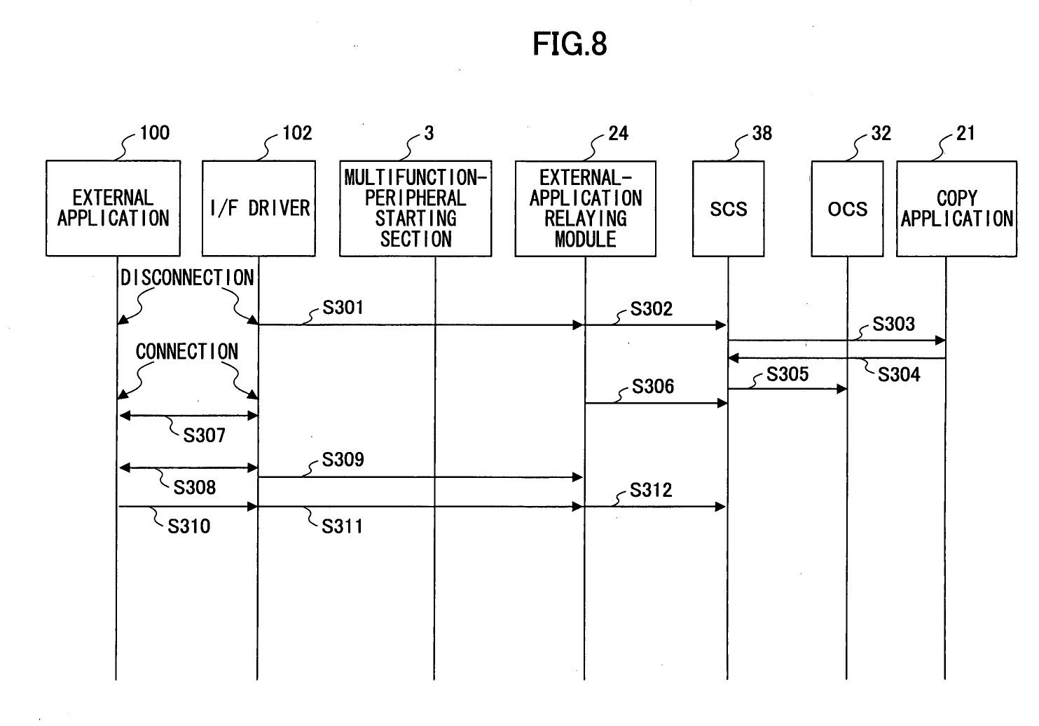

The sequence charts shown in FIG. 4 and FIG. 7 are the basic procedures for registration and unregistration. FIG. 8 is a sequence chart showing a procedure that is performed when physical disconnection occurs such as when the external application 100 is disconnected from the multifunction peripheral 1. In the following, a description will be given of the sequence chart of FIG. 8.

At step S301, when the I/F driver 102 detects a disconnection, the I/F driver 102 notifies the external-application relaying module 24 of “Disconnected State” (see FIG. 6). Having been notified of “Disconnection State”, the external-application relaying module 24 notifies the SCS 38 of application unregistration at step S302.

Like in the case of FIG. 7, if the display of the external application 100 is presented on the operation panel 53 at the time of unregistration, such presentation is brought to an end, followed by presenting another application display. For example, the copy application 21 may present its display. At step S303, the SCS 38 inquires the copy application 21 whether its display can be presented. At step S304, the copy application 21 notifies the SCS 38 that the display can be presented. At step S305, the OCS 32 is instructed to present the display of the copy application 21.

Further, the external-application relaying module 24 sends an application pre-registration preparation notice to the SCS 38 at step S306.

When the external application 100 is subsequently connected, connection signals are exchanged between the I/F driver 102 and the external application 100 at step S307. At step S308, exchanges are made according to a start-up protocol.

At step S309, the I/F driver 102 notifies the external-application relaying module 24 of the starting of the external application 100. The external application 100 attends to application registration with the SCS 38. This application registration is done at steps S310, S311, and S312 through the I/F driver 102 and the external-application relaying module 24.

In this manner, the procedure performed in the case of disconnection is similar to the procedure for unregistering the external application 100. The SCS 38 can register an application of an external apparatus that is connected after the application was unregistered.

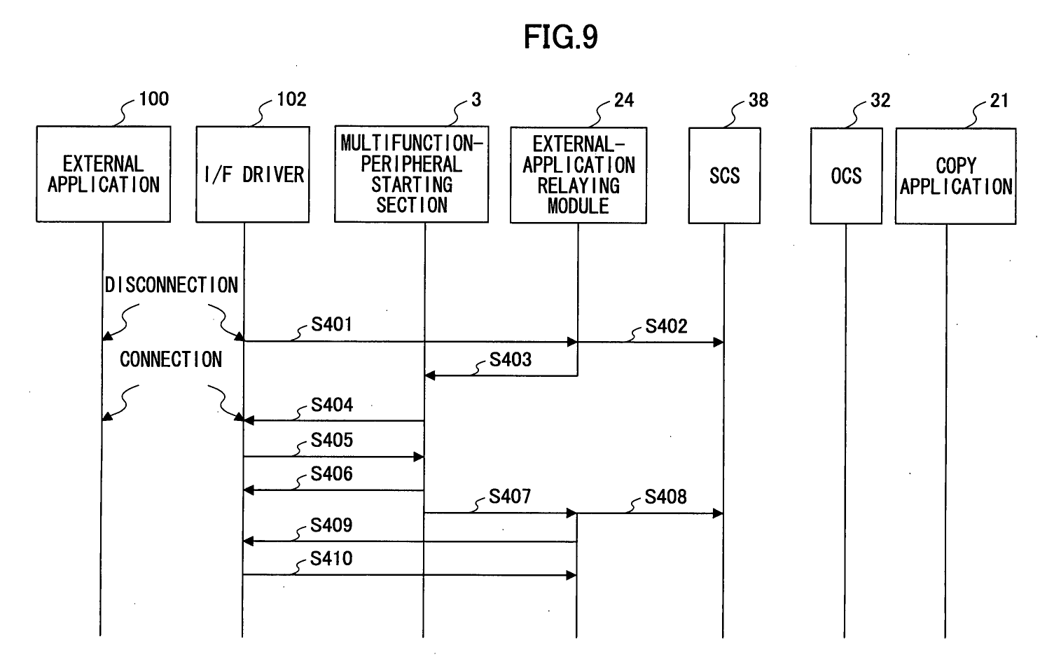

FIG. 9 is a sequence chart showing a procedure that is performed at the time of disconnection. Since the external-application relaying module 24 is not necessary during a time when the external application 100 is disconnected, this procedure unregisters the external-application relaying module 24.

The term “unregistration” means that a memory area having the program of the external-application relaying module 24 laid out therein is released.

In the following, a description will be made of the procedure of FIG. 9.

At step S401, when the I/F driver 102 detects a disconnection, the I/F driver 102 notifies the external-application relaying module 24 of “Disconnected State”—(see FIG. 6). Having been notified of “Disconnection State”, the external-application relaying module 24 notifies the SCS 38 of application unregistration of the external application 100 at step S402. At step S403, the external-application relaying module 24 notifies the multifunction-peripheral starting section 3 of unregistration of the external-application relaying module 24, so that the external-application relaying module 24 is unregistered until the external application 100 is connected again. Thereafter, the external application 100 is connected. At step S404, the multifunction-peripheral starting section 3 executes a system call for letting the I/F driver 102 open a port for the purpose of checking whether the external application 100 is physically connected. At step S405, it is ascertained that physical connection is present if the opening of the port succeeds. At step S406, the port that was opened is closed. At step S407, the multifunction-peripheral starting section 3 starts the external-application relaying module 24.

At step S408, the external-application relaying module 24 sends an application pre-registration preparation notice to the SCS 38.

At step S409, the external-application relaying module 24 executes a system call to let the I/F driver 102 open a port. At step S410, the opening of the port succeeds.

Thereafter, the same procedure as that of step S109 and subsequent steps in the sequence chart of FIG. 4 is performed.

In the manner as described above, the external-application relaying module 24 is unregistered, so that the memory area occupied by the program of the external-application relaying module 24 is released, thereby making it possible to avoid squandering use of memory resources. The external-application relaying module 24, once unregistered, is restarted by the multifunction-peripheral starting section 3 when an external apparatus is connected.

As shown in FIG. 8 and FIG. 9 described above, the multifunction peripheral 1 dynamically copes with addition and removal of the external application 100.

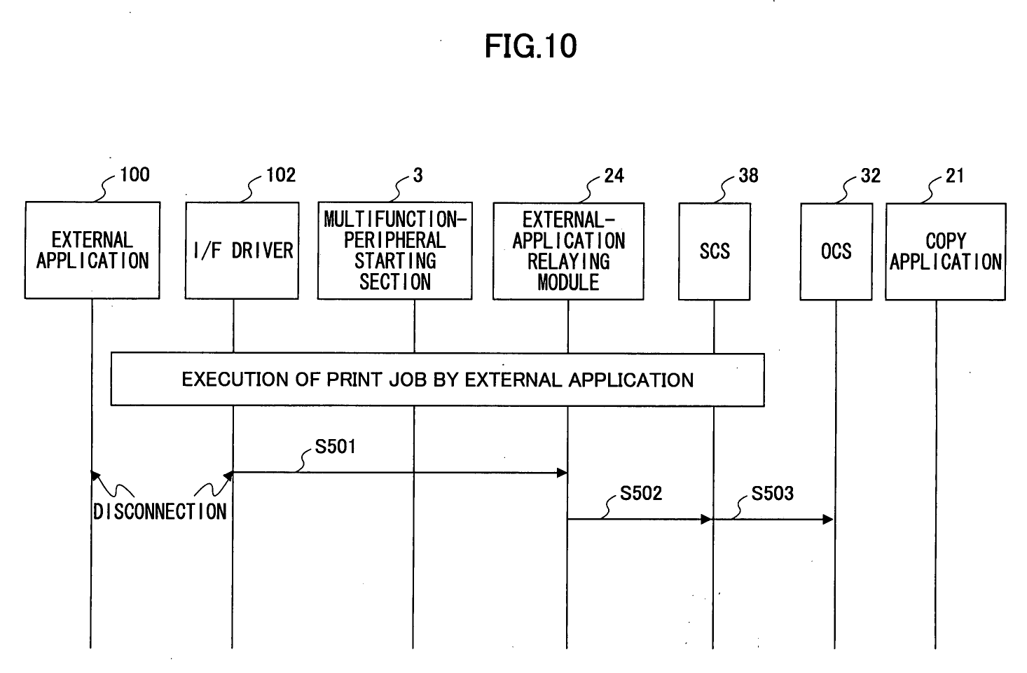

FIG. 10 is a sequence chart showing a procedure that is performed at the time of disconnection. This procedure is carried out when the external application 100 is disconnected during the execution of a print job by the external application 100. When disconnection occurs during the execution of a print job, the right to execute a job cannot be handed over to another application. There is thus a need to present an error message so as to prompt a service person to fix the multifunction peripheral 1.

A description will be given of FIG. 10. At step S501, the I/F driver 102 having detected a disconnection notifies the external-application relaying module 24 of a disconnected state. Having been notified of the disconnected state, the external-application relaying module 24 notifies the SCS 38 at step S502 that an error occurred is such a level as to require service by a service person.

Having been notified of an error, the SCS 38 instructs the OCS 32 to present an error message at step S503, thereby letting the operation panel 53 display an error message.

With this provision, it is possible to cope with disconnection that occurs during the execution of a print job. It should be noted that the SCS 38 may not only present an error message on the operation panel 53, but also send email to a service person or an administrator of the multifunction peripheral 1.

Further, the present invention is not limited to these embodiments, but various variations and modifications may be made without departing from the scope of the present invention.

The present application is based on Japanese priority application No. 2004-54323 filed on Feb. 27, 2004, with the Japanese Patent the entire contents of which are hereby incorporated by reference.

What is claimed is:

1. An image forming apparatus, in which software is used for forming an image, comprising:
a display unit;
a display information controlling unit configured to control information displayed on said display unit;
an interface unit configured to provide a physical connection with an external apparatus on which an application is implemented;
a control unit configured to control said interface unit and provide a logical connection with the external apparatus; and
a relay unit configured to relay between the application and the software, said relaying unit notifying said display information controlling unit of a display that is to be presented on said display unit to indicate ongoing preparation of the application until the application becomes operational when said control unit provides the logical connection with the external apparatus.

2. The image forming apparatus as claimed in claim 1, wherein said display information controlling unit makes said display unit present said display in response to an attempt by a user to use the application.

3. The image forming apparatus as claimed in claim 1, wherein said control unit notifies said relay unit that no communication is possible, in response to a physical or logical disconnection occurring with respect to the external apparatus.

4. The image forming apparatus as claimed in claim 1, further comprising a starting unit configured to start said relay unit.

5. The image forming apparatus as claimed in claim 4, wherein said starting unit starts said relay unit after the external apparatus is physically connected.

6. The image forming apparatus as claimed in claim 4, wherein said starting unit utilizes said control unit to check whether the external apparatus is physically connected.

7. The image forming apparatus as claimed in claim 1, further comprising a registering unit configured to register the application, such registration making the application operable through said image forming apparatus.

8. The image forming apparatus as claimed in claim 7, wherein said registering unit unregisters the application in response to a request from said relay unit.

9. The image forming apparatus as claimed in claim 8, wherein said relay unit requests said registering unit to unregister the application, such request being made in response to a notice from said control unit indicating that no communication is possible.

10. The image forming apparatus as claimed in claim 8, wherein, when said registering unit unregisters the application, said display information controlling unit switches the information displayed on said display unit to other information if the information displayed on said display unit is associated with the application.

11. The image forming apparatus as claimed in claim 10, wherein said other information is associated with the software.

12. The image forming apparatus as claimed in claim 9, wherein said registering unit is configured to register the application again if the external apparatus is reconnected after the application is unregistered.

13. The image forming apparatus as claimed in claim 4, further comprising a program unregistering unit which unregisters said relay unit by releasing a memory area in which a program of said relay unit is laid out.

14. The image forming apparatus as claimed in claim 13, wherein said relay unit, responding to a notice from said control unit indicating that no communication is possible, notifies said starting unit that the application is unregistered, and requests said program unregistering unit to unregister the application.

15. The image forming apparatus as claimed in claim 14, wherein said relay unit is restarted by said starting unit if the external apparatus is connected after said relay unit is unregistered.

16. The image forming apparatus as claimed in claim 3, wherein said relay unit, responding to a notice from said control unit indicating that no communication is possible during execution of the application, notifies said display information controlling unit of a display that is to be presented on said display unit to indicate error occurrence.

17. The image forming apparatus as claimed in claim 3, further comprising an email sending unit, wherein said relay unit, responding to a notice from said control unit indicating that no communication is possible during execution of the application, instructs said email sending unit to send email indicative of error occurrence to a predetermined mail address.

18. A method of allowing an external application to be operated through an image forming apparatus having a display unit, the external application being implemented in an external apparatus connectable to the image forming apparatus, said method comprising the steps of:
connecting the external apparatus to the image forming apparatus;
preparing a display that indicates ongoing preparation until the application becomes operational; and
presenting the display on the display unit until the application becomes operational in response to an attempt by a user to use the application.
